(19) United States
(12) Patent Application Publication
(10) Pub. No.: US 2006/0244355 A1
(43) Pub. Date: Nov. 2, 2006

(54) Plastic substrate for display panel and method of manufacturing the same

(75) Inventors: Kyung-bae Park, Seoul (KR); In-sun Kim, Suwon-si (KR); Hee-nam Hwang, Gunpo-si (KR); Takashi Noguchi, Seongnam-si (KR); Jang-yeon Kwon, Seongnam-si (KR); Young-soo Park, Suwon-si (KR)

Correspondence Address: BUCHANAN, INGERSOLL & ROONEY PC, POST OFFICE BOX 1404, ALEXANDRIA, VA, 22313-1404, US

(73) Assignee: SAMSUNG ELECTRONICS CO., LTD., Suwon-si (KR)

(21) Appl. No.: 11/350,106

(22) Filed: Feb. 9, 2006

(30) Foreign Application Priority Data
Apr. 27, 2005 (KR) 10-2005-0034915

(51) Int. Cl. G09G 3/32; H01K 1/30; H01J 61/40; G09G 3/10; H01J 29/88; G02F 1/361

(52) U.S. Cl. 313/479; 313/110; 313/112; 345/82; 315/169.3; 252/582

(57) ABSTRACT

A plastic substrate for a display panel and method of manufacturing the same are provided. The plastic substrate is obtained by mixing an oligomer of a thermosetting resin, inorganic nanoparticles, and 1,6-hexanedioldiacrylate in a mass ratio of 1:0.8˜1.2:0.8˜1.2. The plastic substrate has transparency and optical isotropy. The method includes preparing a resin composite in which an oligomer of a thermosetting resin, inorganic nanoparticles, 1,6-hexanedioldiacrylate, and a photoinitiator are dissolved and distributed in a solvent; casting a substrate using the resin composite; and curing the substrate by irradiating ultraviolet rays onto the substrate.

### CROSS-REFERENCE TO RELATED PATENT APPLICATION

This application claims the benefit of Korean Patent Application No. 10-2005-0034915, filed on Apr. 27, 2005, in the Korean Intellectual Property Office, the disclosure of which is incorporated herein in its entirety by reference.

### BACKGROUND OF THE DISCLOSURE

1. Field of the Disclosure

The present disclosure relates to a plastic substrate for a display panel and method of manufacturing the same, and more particularly, to a thermosetting plastic substrate for a display panel, which is highly heat-resistant, flexible, and excellent in optical transmittance and optical isotropy, and method of manufacturing the same.

2. Description of the Related Art

In general, a display panel is a flat panel display that is used to output data such as characters, images, or moving pictures for a variety of apparatuses, for example, televisions, monitors, portable data communication terminals, electronic computers, and automobile navigation systems. As an example of the display panel, a liquid crystal display (LCD) includes a transparent electrode and an alignment layer, which are disposed between a front substrate and a rear substrate, and liquid crystals are injected between the front and rear substrates.

A conventional display panel employs a glass substrate. The glass substrate has excellent optical properties, for example, transparency, but conventional techniques have a specific limit when thinning the glass substrate because glass is vulnerable to shock. In addition, it is difficult to make the glass substrate lightweight since glass has a great mass per unit volume. Accordingly, the glass substrate has recently been superseded by a transparent plastic substrate that is resistant to shock and can be lightweight.

However, a conventional plastic substrate is inadequate for a display panel because it is less heat-resistant and has inferior optical properties when compared to a glass substrate. During manufacture of the display panel, the plastic substrate should typically go through a high-temperature process, such as an inorganic layer sputtering process or a plasma-enhanced chemical vapor deposition (PECVD) process. In this environment, the plastic substrate undergoes a thermal transformation, such as expansion or shrinkage, so that the dimensions of the substrate become unstable. In other words, the plastic substrate may be misaligned with other structures.

The thermal transformation of the plastic substrate will be further expressed with reference to FIG. 1, which is a distribution chart showing a distribution of glass transition temperatures of materials for a conventional plastic substrate. The materials for the conventional plastic substrate are thermosetting resins that are transparent and excellent in optical properties. Specifically, FIG. 1 indicates the glass transition temperatures of polycarbonate (PC), polyethersulfone (PES), polyarylate (PAR), polyethylene naphthalate, (PEN), polyethylene terephthalate (PET), and etc. The thermal transition temperatures of the thermosetting polymer resins are approximately 230° C. or lower. Thus, the conventional plastic substrate may be thermally transformed at a temperature of 200° C. or higher. In this environment, the dimensions of the plastic substrate become unstable.

Also, the conventional plastic substrate becomes optically anisotropic through a manufacturing process. Typically, since a plastic substrate formed of a thermosetting resin is made using a melt-extrusion process, its optical properties in a thickness direction are different from those in a surface direction. In particular, an LCD panel, which makes use of optical modulation using liquid crystals to output an image, is more adversely affected because optical anisotropy causes transformation of the image.

Therefore, it is necessary to develop a novel plastic substrate for a display panel, which is so highly heat-resistant as to minimize a thermal transformation and is excellent in transparency and optical isotropy.

### SUMMARY OF THE DISCLOSURE

The present disclosure may provide a plastic substrate for a display panel, which is less thermally transformed at a temperature employed in a display panel manufacturing process and is highly transparent.

Also, the present invention may provide a method of manufacturing a thermosetting transparent plastic substrate to form a plastic substrate that is optically isotropic.

According to an aspect of the present invention, there may be provided a plastic substrate for a display panel, which is obtained by mixing an oligomer of a thermosetting resin, inorganic nanoparticles, and 1,6-hexanedioldiacrylate in a mass ratio of 1:0.8˜1.2 :0.8˜1.2 that has transparency and optical isotropy.

The thermosetting resin may be acrylate or epoxy, and the inorganic nanoparticles may be silica nanoparticles. 1,6-hexanedioldiacrylate is an example of an additive having a low thermosetting degree that prevents the bending breakage of the plastic substrate.

According to another aspect of the present invention, there may be provided a method of manufacturing a plastic substrate for a display panel, which includes mixing an oligomer of a thermosetting resin, inorganic nanoparticles, and 1,6-hexanedioldiacrylate in a mass ratio of 1:0.8˜1.2:0.8˜1.2 and preparing a resin composite for the plastic substrate by dissolving the mixture and a photoinitiator in a solvent; casting a substrate by injecting the resin composite in a substrate mold and baking the resin composite; and curing the substrate by irradiating ultraviolet rays onto the substrate.

The inorganic nanoparticles may be silica nanoparticles that are distributed in an acrylate monomer. Also, the casting of the substrate may be performed while applying substantially the same pressure to the substrate in all directions.

### BRIEF DESCRIPTION OF THE DRAWINGS

The above and other features and advantages of the present invention are apparent by the description of detailed exemplary embodiments thereof with reference to the attached drawings in which:

FIG. 1 is a distribution chart showing glass transition temperatures of materials for a conventional plastic substrate;

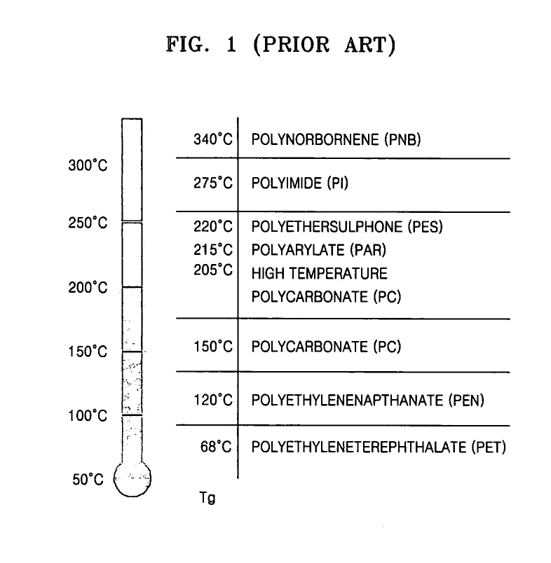

FIG. 2 is a graph showing optical properties of a plastic substrate according to an exemplary embodiment of the present invention; and

FIG. 3 is a graph showing the thermal transformation property of the plastic substrate according to the exemplary embodiment of the present invention.

### DETAILED DESCRIPTION OF THE EXEMPLARY EMBODIMENTS

A plastic substrate for a display panel according to the present invention will now be described more fully hereinafter with reference to the accompanying drawings, in which exemplary embodiments of the invention are shown.

In order to enhance heat resistance, a plastic substrate according to the present invention is formed of an organic-inorganic mixture that is obtained by mixing a thermosetting resin whose glass transition temperature is about 300° C. or higher with inorganic nanoparticles. Also, to make the plastic substrate transparent, acryl or epoxy may be used as the thermosetting resin, and silica nanoparticles may be adopted as the inorganic nanoparticles. The silica nanoparticles may have a particle diameter of several to several tens of nm. The silica nanoparticles may be distributed in an acrylate or epoxy monomer according to the type of the thermosetting resin used for the plastic substrate and then mixed with the thermosetting resin.

In general, when inorganic particles, such as silica particles, are mixed with a thermosetting resin, the resultant plastic substrate can be more heat-resistant but becomes turbid. However, the plastic substrate can be kept transparent by mixing nanoscale inorganic particles with the thermosetting resin. The thermosetting resin and the inorganic nanoparticles may be mixed in a mass ratio of about 1 to 0.8˜1.2. It is difficult to obtain a sufficient improvement in heat resistance as might be the case where the inorganic nanoparticles are present in an inadequate quantity, while the plastic substrate is easily cracked or broken when it is bent as might be the case where the inorganic nanoparticles are too present in an excessive quantity.

A thermosetting resin (esp., a thermosetting resin product in which inorganic particles are distributed) is easily broken by bending owing to a lack of ductility. Therefore, an additive having a low thermosetting degree, for example, 1,6-hexanedioldiacrylate, is additionally provided in the plastic substrate of the present invention. The additive may be present in the thermosetting resin in a mass ratio of about 1 to 0.8˜1.2. As a result, even if the plastic substrate is bent, undesirable cracking and breaking is diminished. Further, the plastic substrate can meet the necessary conditions (e.g., flexural strength) as a substrate for a flexible display panel.

Hereinafter, a method of manufacturing a plastic substrate for a display panel will be described in detail with reference to an exemplary embodiment according to the present invention.

Initially, a solution is prepared in which silica nanoparticles are distributed in a thermosetting resin. This solution is obtained by distributing nanoscale silica particles in an acrylate-based monomer. A urethane acrylate material and a photoinitiator for ultraviolet (UV) curing are added to the prepared solution. The acrylate material may be a mixture of acrylate having one functional group, acrylate having two functional groups, and acrylate having three functional groups. An acrylate oligomer having several functional groups may be added to the acrylate material to enhance hardness and formability. The acrylate material is distributed using a solvent, such as methyl ethyl ketone (MEK) to facilitate the processing of the solution, and the photoinitiator should be appropriate for manufacture of a transparent film. Thus, a resin composite for a plastic substrate is prepared.

The method of manufacturing a plastic substrate according to the present invention makes use of a solution casting technique. A substrate mold having a predetermined size and thickness is prepared along with the solution (i.e., the resin composite for the plastic substrate), correctly aligned in a horizontal direction, and installed in an oven. The solution is poured in the prepared mold and dried at a temperature of 80° C. for a predetermined time until the solvent evaporates. For example, when the plastic substrate is manufactured to a thickness of 120 μm, the solution can be poured in the prepared mold and dried at a temperature of 80° C. for about 30 minutes. After the drying process, UV rays are irradiated onto the substrate so that the substrate can be cured, and the cured substrate is separated from the mold.

During the above-described process, substantially the same pressure may be applied to the plastic substrate in all directions. A conventional method of manufacturing a plastic substrate employs a melt-extrusion process in which an uncured thermosetting resin is melted at a high temperature and extruded in a certain direction. In this case, however, there is a difference between pressures applied in a thickness direction and a surface direction of the substrate or between pressures applied in a lengthwise direction and a widthwise direction of the substrate. As a result, the completed substrate becomes optically anisotropic. For this reason, in the present invention, the resin composite is poured in a predetermined mold and is slowly dried under a constant pressure so that a plastic substrate can be optically isotropic.

Hereinafter, a method of manufacturing a plastic substrate according to an exemplary embodiment of the present invention, a comparative example, and an experimental example will be described. This invention may, however, be embodied in different forms and should not be construed as limited to the embodiments set forth herein. Rather, these embodiments are provided for exemplary purposes.

### Embodiment 1

10 g of an acrylated silicated nanoparticle solution from DSM as inorganic nanoparticles, 10 g of 1,6-hexanedioldiacrylate as an additive having a low thermosetting degree, 10 g of an aliphatic urethane acrylate oligomer from UCB as a thermosetting resin oligomer, and 1.5 g of irgacure84 from IRGACURE as a photoinitiator are distributed and dissolved in 50 g of an MEK solvent for three hours, to prepare a resin composite for a plastic substrate.

In addition, a circular mold with a diameter of 10 cm is installed in an oven and is aligned in a horizontal direction. The resin composite is poured in the mold and is dried at a temperature of about 80° C. for 30 minutes. Then, the resin composite cast in the mold is cured by irradiating UV rays at a room temperature. Thereafter, a substrate having a thickness of about 120 μm is detached from the mold.

### Comparative Example 1

A conventional method of manufacturing a transparent plastic substrate using polyethersulfone (PES) is described. PES is a thermosetting resin that is excellent in optical properties and heat-resistance. PES is sufficiently melted at a glass transition temperature of 230° C. or higher, cooled and stabilized in a continuous form (e.g., a film, sheet, or pipe) through a roll contact process, and then is processed to a desired length or width. In this process, a plastic substrate having a thickness of 200 μm is obtained.

### Experimental Example 1

The physical properties of the plastic substrate according to the above-described Embodiment 1 were measured. Initially, before and after the plastic substrate was thermally treated at a temperature of 180° C. for 30 minutes, the optical transmittance of the plastic substrate was measured.

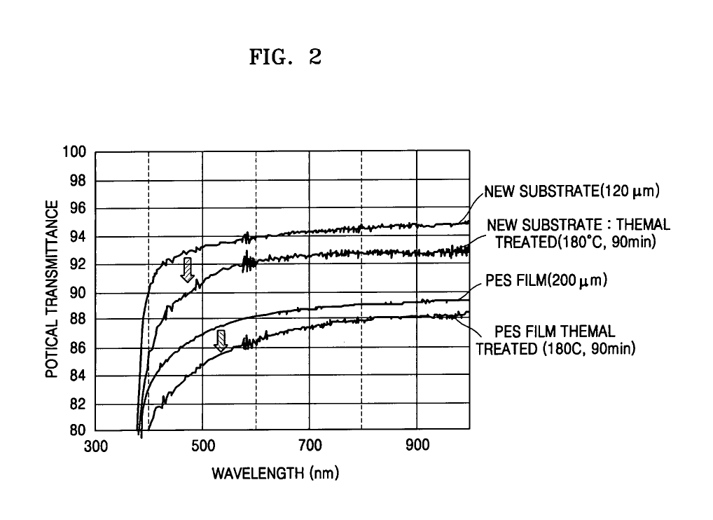

FIG. 2 is a graph showing optical properties of the plastic substrate according to the Embodiment 1. Referring to FIG. 2, the plastic substrate according to the Embodiment 1 has even higher transmittance than the PES substrate mentioned in the Comparative Example 1. Similarly, even if a thermal treatment were performed at a temperature of 180° C. for 30 minutes, the plastic substrate according to the Embodiment 1 was still superior in transmittance to the Comparative Example 1.

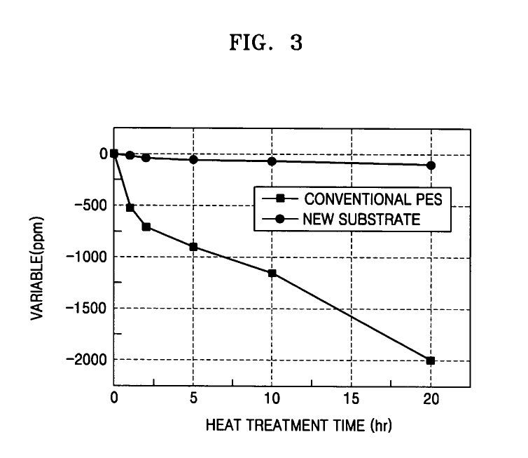

Furthermore, in order to evaluate the extent of a thermal transformation of a plastic substrate through a display panel manufacturing process, a variation in the length of the substrate over time was measured when the substrate was thermally treated in an oven at a temperature of 200° C. for 20 hours. The numerical values of measurements are arranged in Table 1 and are graphically represented in FIG. 3.

TABLE 1

| Heat | Comparative Example 1 | | Embodiment 1 | |
|---|---|---|---|---|
| Treatment | (PES substrate) | | (New substrate) | |
| Time | Length variation | | Length variation | |
| (200° C.) | (μm/cm) | ppm | (μm/cm) | ppm |
| 1 hour | −5.2 | −520 | −0.13 | −13 |
| 2 hours | −7.1 | −710 | −0.35 | −35 |
| 5 hours | −9.0 | −900 | −0.47 | −47 |
| 10 hours | −11.5 | −1150 | −0.68 | −68 |
| 20 hours | −20.0 | −2000 | −0.97 | −97 |

As can be seen from Table 1 and FIG. 3, the plastic substrate according to the present invention had about 1/20 the length variation of the conventional PES substrate. Therefore, when the plastic substrate according to the present invention is used for a display panel, its dimensions can be stabilized.

The following Table 2 shows a result of measurements of optical anisotropy of the plastic substrates according to the Comparative Example 1 and the Embodiment 1 using a polarimeter.

TABLE 2

| | Comparative Example 1 | Embodiment 1 |
|---|---|---|
| Optical anisotropy | (PES substrate) | (New substrate) |
| Before Heat Treatment | 24.6 nm | 8.5 nm |
| After Heat Treatment | 13.9 nm | 3.5 nm |
| (200° C., 30 min.) | | |

As can be seen from Table 2, the plastic substrate of the Embodiment 1 was far less optically anisotropic than the Comparative Example 1 both before and after the heat treatment. Therefore, since the plastic substrate according to the present invention is excellent with respect to its optical isotropy, it is appropriate for a display panel.

According to the present invention as described above, a plastic substrate is seldom thermally transformed at a temperature encountered for use in a typical display panel process. Also, the plastic substrate of the present invention is flexible and has optical properties that are well fit for a display panel.

Further, according to the method of the present invention, because a transparent thermosetting resin is molded using a solution casting process, the plastic substrate can be optically isotropic.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A plastic substrate for a display panel which is obtained by mixing an oligomer of a thermosetting resin, inorganic nanoparticles, and 1,6-hexanedioldiacrylate in a mass ratio of 1:0.8˜1.2:0.8˜1.2 that has transparency and optical isotropy.

2. The plastic substrate of claim 1, wherein the thermosetting resin is an acrylate or epoxy.

3. The plastic substrate of claim 1, wherein the thermosetting resin is a urethane acrylate.

4. The plastic substrate of claim 1, wherein the inorganic nanoparticles are silica nanoparticles.

5. The plastic substrate of claim 1, wherein the oligomer of the thermosetting resin, the inorganic nanoparticles, and the 1,6-hexanedioldiacrylate are mixed in a mass ratio of about 1:1:1.

6. The plastic substrate of claim 5, wherein the oligomer of the thermosetting resin is a urethane acrylate oligomer, and the inorganic nanoparticles are silica nanoparticles.

7. A method of manufacturing a plastic substrate for a display panel, the method comprising:
mixing an oligomer of a thermosetting resin, inorganic nanoparticles, and 1,6-hexanedioldiacrylate in a mass ratio of 1:0.8˜1.2:0.8˜1.2 and preparing a resin composite for the plastic substrate by dissolving the mixture and a photoinitiator in a solvent;
casting a substrate by injecting the resin composite in a substrate mold and baking the resin composite; and
curing the substrate by irradiating ultraviolet rays onto the substrate.

8. The method of claim 7, wherein the solvent is MEK (methyl ethyl ketone).

9. The method of claim 7, wherein the thermosetting resin is an acrylate or epoxy.

10. The method of claim 7, wherein the thermosetting resin is a urethane acrylate.

11. The method of claim 10, wherein the inorganic nanoparticles are silica nanoparticles that are distributed in an acrylate-based monomer.

12. The method of claim 7, wherein the casting of the substrate is performed while applying substantially the same pressure to the substrate in all directions.

13. The method of claim 7, wherein an oligomer of a thermosetting resin, inorganic nanoparticles, and 1,6-hexanedioldiacrylate are mixed in a mass ratio of about 1:1:1 and a resin composite for the plastic substrate is prepared by dissolving the mixture and a photoinitiator in a solvent.

14. A resin composite for a plastic substrate in which a urethane acrylate oligomer, inorganic nanoparticles, 1,6-hexanedioldiacrylate, and a photoinitiator are mixed in a mass ratio of 1:0.8˜1.2:0.8˜1.2:0.05˜0.25 and dissolved in an MEK solvent.
